(19) United States
(12) Patent Application Publication
(10) Pub. No.: US 2018/0337525 A1
(43) Pub. Date: Nov. 22, 2018

(54) PROTECTIVE DEVICE AND POWER SOURCE SYSTEM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Junpei Horii, Yokkaichi, Mie (JP)

(73) Assignees: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(21) Appl. No.: 15/777,764

(22) PCT Filed: Dec. 13, 2016
(86) PCT No.: PCT/JP2016/087084

§ 371 Date: May 21, 2018

(30) Foreign Application Priority Data
Dec. 25, 2015 (JP) 2015-254882

(51) Int. Cl. H02H 3/20; H02H 1/06; B60R 16/02; H02H 3/04

(52) U.S. Cl. CPC H02H 3/20; H02H 1/06; B60R 16/023; H02H 3/046; B60R 16/02

(57) ABSTRACT

In a protective device fuses are respectively provided in three current paths from a battery to respective loads. A microcomputer outputs, to a synthesis circuit, pulse signals having pulses in mutually-different positions. The pulse signals correspond to the fuses, respectively. The synthesis circuit synthesizes a pulse signal corresponding to a fuse, among the fuses, that has a voltage on a downstream-side end less than a threshold. The microcomputer identifies a blown fuse on the basis of a synthesized signal synthesized by the synthesis circuit.

### CROSS-REFERENCE TO RELATED APPLICATIONS

This application is the U.S. national stage of PCT/JP2016/087084 filed Dec. 13, 2016, which claims priority of Japanese Patent Application No. 2015-254882 filed on Dec. 25, 2015, which is incorporated herein by reference in its entirety.

### FIELD OF THE INVENTION

The present description relates to a protective device having a fuse provided in a current path from a battery to a load, and to a power source system including such a protective device.

### BACKGROUND OF THE INVENTION

Power source systems that supply power from a battery to a plurality of loads are installed in vehicles. Among such power source systems, there are power source systems including protective devices that protect the plurality of loads from overcurrent (see JP 2008-296863A, for example).

The protective device disclosed in JP 2008-296863A has a plurality of fuses respectively provided in a plurality of current paths from a battery to a corresponding plurality of loads. When current greater than or equal to a predetermined current flows in one of the current paths, the fuse provided in that current path will blow, which protects the load from overcurrent.

Additionally, in the protective device disclosed in JP 2008-296863A, a series circuit constituted by a resistor and a light-emitting diode is connected in parallel to each of the plurality of fuses. When a fuse is not blown, a voltage across both ends of the series circuit connected in parallel to that fuse is substantially zero V. As such, no current flows in the series circuit, and the light-emitting diode included in that series circuit does not emit light. If the fuse has blown, current flows in the series circuit connected in parallel to that fuse, and the light-emitting diode included in that series circuit emits light.

In the protective device disclosed in JP 2008-296863A, a single light-receiving element receives the light emitted by each of the plurality of light-emitting diodes. The resistance values of the resistors included in the plurality of series circuits are different from one another, or the distances between the plurality of light-emitting diodes included in the plurality of series circuits and the light-receiving element are different from each other. Accordingly, if the plurality of light-emitting diodes emit light at the same intensity when current of the same magnitude flows therein, the light-emitting diode that is emitting light, i.e. the fuse that has blown, can be identified on the basis of the intensity of the light received by the light-receiving element.

### SUMMARY OF THE INVENTION

However, in the protective device disclosed in JP 2008-296863A, skew in the orientations of light-emitting surfaces of the light-emitting diodes, a drop in the intensity of light emitted by the light-emitting diodes, and so on make it easy for error to arise in the intensity of the light received by the light-receiving element. There is thus a problem that the blown fuse cannot be identified with a high level of accuracy.

Having been conceived in light of such circumstances, an object of the present description is to provide a protective device that makes it possible to identify a blown fuse with a high level of accuracy, and a power source system including such a protective device.

A protective device according to the present description is a protective device including a plurality of fuses respectively provided in a plurality of current paths from a battery to a corresponding plurality of loads, the device including: an output unit that outputs a plurality of pulse signals, each of the pulse signals corresponding to one of the plurality of fuses, and the pulse signals having pulses in mutually-different positions; a synthesis circuit that synthesizes a pulse signal, among the plurality of pulse signals outputted by the output unit, corresponding to a fuse that has a voltage on a downstream-side end less than a threshold (or greater than or equal to a threshold); and an identifying unit that identifies a blown fuse on the basis of the synthesized signal synthesized by the synthesis circuit.

In the present description, the plurality of fuses are respectively provided in the plurality of current paths from the battery to the corresponding plurality of loads. When the fuses are not blown, the voltages at the downstream-side ends thereof each substantially matches the output voltage of the battery and is greater than or equal to the threshold. However, when the fuses are blown, the voltages at the downstream-side ends thereof each is substantially zero V, and is less than the threshold.

The output unit outputs the plurality of pulse signals, which have pulses in mutually-different positions. Here, the plurality of pulse signals correspond respectively to the plurality of fuses. The synthesis circuit synthesizes a pulse signal, among the plurality of pulse signals outputted by the output unit, that corresponds to a fuse that is blown (or is not blown). The blown fuse is identified on the basis of the position where a pulse is present (or the position where a pulse is not present) in the synthesized signal synthesized by the synthesis circuit. In this manner, a blown fuse can be identified with a high level of accuracy on the basis of the downstream-side end voltage.

In a protective device according to the present description, the synthesis circuit includes: a plurality of input terminals into which the plurality of pulse signals are respectively inputted; a plurality of switches, each of the switches corresponding to one of the plurality of fuses, and one end of each of the switches being connected to a corresponding one of the plurality of input terminals; and an output terminal connected to another end of each of the plurality of switches. Here, each of the plurality of switches is configured to allow a corresponding one of the pulse signals to pass in the case where the voltage on the downstream-side end of the fuse corresponding to that switch is less than the threshold (or greater than or equal to the threshold).

In the present description, the plurality of pulse signals are inputted into the plurality of input terminals, respectively. One end of each of the plurality of switches is connected to a corresponding one of the plurality of input terminals, and another end of each of the plurality of switches is connected to the output terminal. Each of the plurality of switches allows a pulse signal to pass when the fuse corresponding to that switch is blown (or when the fuse corresponding to that switch is not blown). In this manner, the synthesis circuit can be configured simply, using a plurality of switches.

A protective device according to the present description is a protective device including a plurality of fuses respectively provided in a plurality of current paths from a battery to a corresponding plurality of loads, the plurality of fuses being divided into K (≥2) fuse groups, and the device including: an output unit that outputs a plurality of pulse signals, each of the pulse signals corresponding to one fuse belonging to each of one or more fuse groups among the K fuse groups, and the pulse signals having pulses in mutually-different positions; K synthesis circuits, each corresponding to one of the K fuse groups, that each synthesizes a pulse signal, among M (≥2) pulse signals outputted by the output unit and corresponding to M fuses belonging to the fuse group to which that synthesis circuit corresponds, corresponding to a fuse that has a voltage on a downstream-side end less than a threshold (or greater than or equal to a threshold); a selecting unit that selects one of the K synthesized signals synthesized by the K synthesis circuits; a second output unit that outputs the synthesized signal selected by the selecting unit; and an identifying unit that identifies a blown fuse on the basis of the synthesized signal outputted by the second output unit.

In the present description, the plurality of fuses are respectively provided in the plurality of current paths from the battery to the corresponding plurality of loads. When the fuses are not blown, the voltages at the downstream-side ends thereof each substantially matches the output voltage of the battery and is greater than or equal to the threshold. However, when the fuses are blown, the voltages at the downstream-side ends thereof each is substantially zero V, and is less than the threshold.

The plurality of fuses are divided into K fuse groups. The output unit outputs the plurality of pulse signals, which have pulses in mutually-different positions. Here, each of the plurality of pulse signals corresponds to a fuse included in each of one or more fuse groups among the K fuse groups. For example, one pulse signal corresponds to one fuse belonging to each of two fuse groups among the K fuse groups.

The K synthesis circuits correspond to the K fuse groups, respectively. Each of the K synthesis circuits synthesizes a pulse signal, among the M pulse signals corresponding to the M fuses belonging to the fuse group corresponding to that synthesis circuit, that corresponds to a fuse that is blown (or that is not blown). A blown fuse, among the plurality of fuses belonging to the fuse group corresponding to a synthesis circuit, is identified on the basis of the position where a pulse is present (or the position where a pulse is not present) in the synthesized signal synthesized by that synthesis circuit. The synthesized signal outputted by the second output unit can be changed by changing the selected synthesized signal, and whether or not a fuse is blown can be determined for all of the fuses.

As such, a blown fuse can be identified with a high level of accuracy on the basis of the downstream-side end voltage. Furthermore, a plurality of fuses can be associated with a single pulse signal, and thus the output unit outputs a lower number of pulse signals.

In a protective device according to the present description, each of the K synthesis circuits includes: M input terminals into which the respective M pulse signals corresponding to the M fuses belonging to the fuse group to which the synthesis circuit corresponds are inputted; M switches, each of the switches corresponding to one of the M fuses, and one end of each of the switches being connected to a corresponding one of the M input terminals; and an output terminal connected to another end of each of the M switches. Here, each of the M switches is configured to allow a corresponding one of the pulse signals to pass in the case where the voltage on the downstream-side end of the fuse corresponding to that switch is less than the threshold (or greater than or equal to the threshold).

In the present description, in each of the K synthesis circuits, the M pulse signals are inputted into the M input terminals, respectively. One end of each of the M switches is connected to a corresponding one of the M input terminals, and another end of each of the M switches is connected to the output terminal. Each of the M switches allows a pulse signal to pass when the fuse corresponding to that switch is blown (or when the fuse corresponding to that switch is not blown). In this manner, the synthesis circuit can be configured simply, using switches.

A power source system according to the present description includes the above-described protective device; the battery; and the plurality of loads, the loads being supplied with power from the battery via the protective device.

In the present description, power is supplied from the battery to the plurality of loads via the above-described protective device. In the protective device, if current greater than or equal to a predetermined current flows to one of the loads, the fuse connecting that load to the battery blows. Each of the plurality of fuses are therefore protected from overcurrent.

According to the present description, a blown fuse can be identified with a high level of accuracy.

### BRIEF DESCRIPTION OF THE DRAWINGS

FIG. 1 is a block diagram illustrating the primary configuration of a power source system according to a first embodiment.

FIG. 2 is a block diagram illustrating the primary configuration of a protective device.

FIG. 3 is a circuit diagram illustrating a synthesis circuit.

FIG. 4 is a waveform diagram illustrating pulse signals and synthesized signals.

FIG. 5 is a flowchart illustrating a sequence of operations executed by a microcomputer.

FIG. 6 is a block diagram illustrating the primary configuration of a power source system according to a second embodiment.

FIG. 7 is a block diagram illustrating the primary configuration of a protective device according to the second embodiment.

FIG. 8 is a waveform diagram illustrating pulse signals and synthesized signals.

FIG. 9 is a table for describing operations of a switching circuit.

FIG. 10 is a flowchart illustrating a sequence of operations executed by a microcomputer.

FIG. 11 is a circuit diagram illustrating a synthesis circuit according to a third embodiment.

FIG. 12 is a waveform diagram illustrating synthesized signals.

### DETAILED DESCRIPTION OF THE PREFERRED EMBODIMENTS

The present description will be described in detail hereinafter on the basis of drawings illustrating embodiments thereof.

### First Embodiment

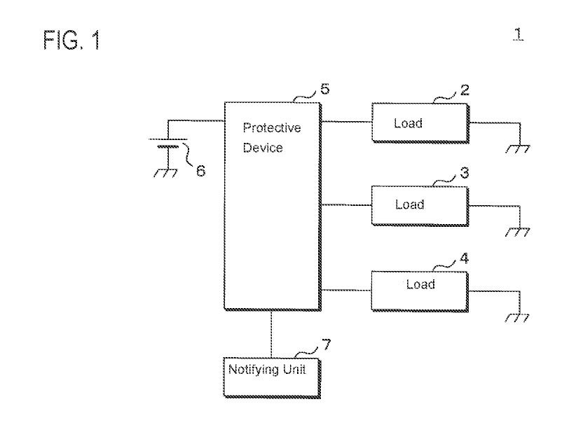

FIG. 1 is a block diagram illustrating the primary configuration of a power source system 1 according to a first embodiment. The power source system 1 can be favorably installed in a vehicle, and includes three loads 2, 3, and 4, a protective device 5, a battery 6, and a notifying unit 7. The positive terminal of the battery 6 is connected to the protective device 5. The notifying unit 7 and one end of each of the loads 2, 3, and 4 are further connected to the protective device 5. The negative terminal of the battery 6 and the other end of each of the loads 2, 3, and 4 are grounded.

The battery 6 supplies power to the three loads 2, 3, and 4 via the protective device 5. The loads 2, 3, and 4 operate using the power supplied from the battery 6.

The protective device 5 protects the loads 2, 3, and 4 from overcurrent. When current greater than or equal to a predetermined current flows from the battery 6 to at least one of the loads 2, 3, and 4, the connection between the battery 6 and the load, among the loads 2, 3, and 4, in which the current greater than or equal to the predetermined current is flowing, is cut off, and a notification signal is outputted to the notifying unit 7. When the notification signal is inputted, the notifying unit 7 makes a notification by displaying a message in a display unit (not illustrated), lighting a lamp (not illustrated), or the like.

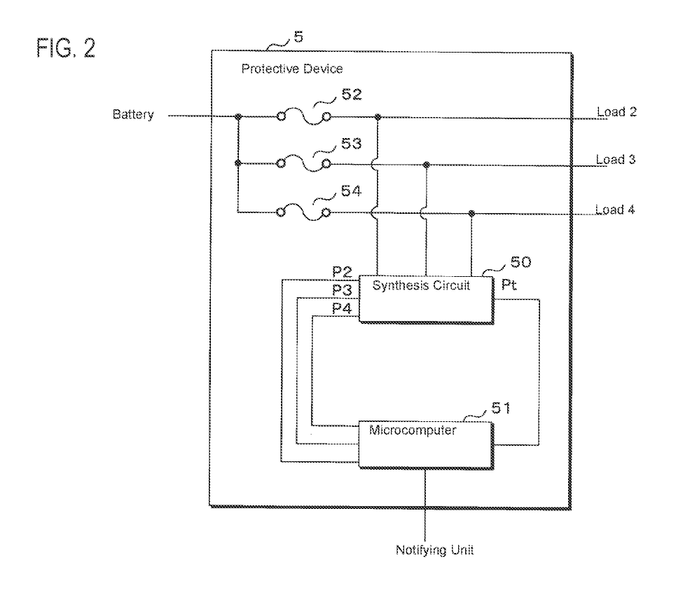

FIG. 2 is a block diagram illustrating the primary configuration of the protective device 5. The protective device 5 includes a synthesis circuit 50, a microcomputer 51, and three fuses 52, 53, and 54. One end of each of the fuses 52, 53, and 54 is connected to the positive terminal of the battery 6. The other ends of the fuses 52, 53, and 54 are connected to the one ends of the loads 2, 3, and 4, respectively.

Current flows from the positive terminal of the battery 6 to the loads 2, 3, and 4 via the fuses 52, 53, and 54, respectively. Thus in the protective device 5, three current paths are provided from the battery 6 to the loads 2, 3, and 4, respectively, and the three fuses 52, 53, and 54 are provided in the three current paths, respectively. Each of the fuses 52, 53, and 54 blows when current greater than or equal to a predetermined current flows in that fuse. The connection between the positive terminal of the battery 6 and the load connected to the other end of the blown fuse is cut off as a result.

Each of the downstream-side ends of the fuses 52, 53, and 54 is connected to the synthesis circuit 50. The synthesis circuit 50 is further connected to the microcomputer 51. The microcomputer 51 is further connected to the notifying unit 7.

The voltage at the downstream-side end of each of the fuses 52, 53, and 54, i.e. the voltage across both ends of each of the loads 2, 3, and 4, is inputted into the synthesis circuit 50. When the fuses 52, 53, and 54 are not blown, the voltages at the downstream-side ends thereof, which take a ground potential as a reference, each substantially matches the output voltage of the battery 6, and is greater than or equal to a pre-set threshold. However, when the fuses 52, 53, and 54 are blown, the voltages at the downstream-side ends thereof, which take the ground potential as a reference, each is substantially zero V, and is less than the threshold.

The microcomputer 51 includes a CPU (Central Processing Unit; not illustrated), and carries out various processes by executing control programs stored in a storage unit (not illustrated). The microcomputer 51 outputs, to the synthesis circuit 50, three pulse signals P2, P3, and P4 corresponding to the three fuses 52, 53, and 54, respectively. The microcomputer 51 functions as an output unit. The synthesis circuit 50 synthesizes a pulse signal, of the three pulse signals P2, P3, and P4 outputted by the microcomputer 51, corresponding to a fuse having a downstream-side end voltage that is less than the threshold, and outputs a synthesized signal Pt obtained from the synthesis to the microcomputer 51. The voltages of the pulse signals P2, P3, and P4 and the synthesized signal Pt are voltages that take the ground potential as a reference.

Note that if there is no fuse, among the three fuses 52, 53, and 54, having a downstream-side end voltage that is less than the threshold, the synthesized signal Pt remains substantially zero V. If there is one fuse, among the three fuses 52, 53, and 54, having a downstream-side end voltage that is less than the threshold, the synthesized signal Pt matches the pulse signal corresponding to the fuse having a downstream-side end voltage that is less than the threshold. For example, if the fuse 53 has blown, the synthesized signal Pt matches the pulse signal P3.

The microcomputer 51 identifies a blown fuse among the three fuses 52, 53, and 54 on the basis of the synthesized signal Pt inputted from the synthesis circuit 50. When there is a blown fuse among the three fuses 52, 53, and 54, the microcomputer 51 outputs, to the notifying unit 7, a notification signal indicating the one or more fuses that are blown. Upon the notification signal being inputted from the microcomputer 51, the notifying unit 7 makes a notification about the one or more fuses indicated by the notification signal, by displaying a message in the display unit, lighting the lamp, or the like.

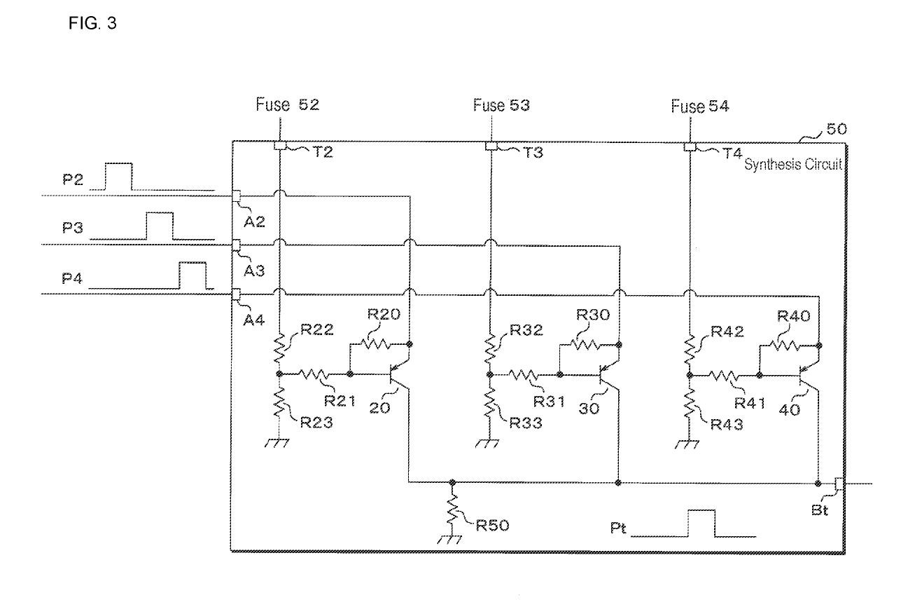

FIG. 3 is a circuit diagram illustrating the synthesis circuit 50. The synthesis circuit 50 includes semiconductor switches 20, 30, and 40; resistors R20, R21, R22, R23, R30, R31, R32, R33, R40, R41, R42, R43, and R50; input terminals A2, A3, A4, T2, T3, and T4; and an output terminal Bt. Each of the semiconductor switches 20, 30, and 40 is a PNP bipolar transistor.

Each of the input terminals A2, A3, and A4 is connected to the microcomputer 51. The pulse signals P2, P3, and P4 are inputted to the input terminals A2, A3, and A4, respectively. The input terminals T2, T3, and T4 are connected to the downstream-side ends of the fuses 52, 53, and 54, respectively. The voltages at the downstream-side ends of the fuses 52, 53, and 54 are inputted to the input terminals T2, T3, and T4, respectively. The output terminal Bt is connected to the microcomputer 51. The synthesized signal Pt is outputted to the microcomputer 51 from the output terminal Bt.

In the synthesis circuit 50, the input terminal A2 is connected to the emitter of the semiconductor switch 20. The resistor R20 is connected between the emitter and the base of the semiconductor switch 20. Furthermore, one end of the resistor R21 is connected to the base of the semiconductor switch 20. The other end of the resistor R21 is connected to one end of each of the resistors R22 and R23. The other end of the resistor R22 is connected to the input terminal T2. The other end of the resistor R23 is grounded.

The semiconductor switch 30, the resistors R30, R31, R32, and R33, and the input terminals A3 and T3 are connected in the same manner as the semiconductor switch 20, the resistors R20, R21, R22, and R23, and the input terminals A2 and T2. The semiconductor switch 40, the resistors R40, R41, R42, and R43, and the input terminals A4 and T4 are connected in the same manner as the semiconductor switch 20, the resistors R20, R21, R22, and R23, and the input terminals A2 and T2. Each of the collectors of the semiconductor switches 20, 30, and 40 is connected to one end of the resistor R50 and the output terminal Bt. The other end of the resistor R50 is grounded.

In each of the semiconductor switches 20, 30, and 40, current can flow between the emitter and the collector when a voltage at the base, which takes a potential at the emitter as a reference, is less than a negative predetermined voltage. The semiconductor switches 20, 30, and 40 are on at this time. In each of the semiconductor switches 20, 30, and 40, current does not flow between the emitter and the collector when the voltage at the base, which takes a potential at the emitter as a reference, is greater than or equal to the predetermined voltage. The semiconductor switches 20, 30, and 40 are off at this time.

The resistors R22 and R23 divide the voltage inputted to the input terminal T2, and apply the divided voltage to the base of the semiconductor switch 20 via the resistor R21. The resistors R32 and R33 function the same way as the resistors R22 and R23, and the resistors R42 and R43 also function the same way as the resistors R22 and R23. Accordingly, the resistors R32 and R33 divide the voltage inputted to the input terminal T3, and apply the divided voltage to the base of the semiconductor switch 30 via the resistor R31. The resistors R42 and R43 divide the voltage inputted to the input terminal T4, and apply the divided voltage to the base of the semiconductor switch 40 via the resistor R41.

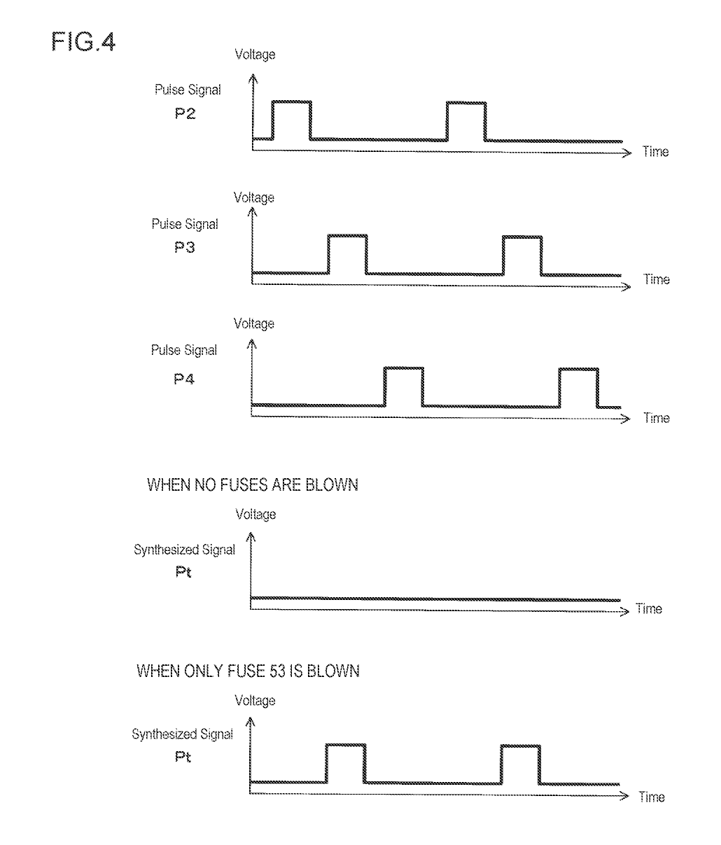

FIG. 4 is a waveform diagram illustrating the pulse signals P2, P3, and P4 and the synthesized signal Pt. FIG. 4 illustrates the waveform of the synthesized signal Pt when none of the fuses 52, 53, and 54 are blown, and the waveform of the synthesized signal Pt when the fuse 53 is blown.

Each of the pulse signals P2, P3, and P4 is generated by the microcomputer 51 outputting a rectangular pulse in a constant period. The periods, pulsewidths, and pulse amplitudes of the pulse signals P2, P3, and P4 are substantially the same. The position of the pulse is different for each of the pulse signals P2, P3, and P4. In the pulse signals P2, P3, and P4, the pulse amplitudes are higher than a predetermined voltage, and the parts aside from the pulses are substantially zero V.

If the fuse 52 is not blown, i.e. if the voltage at the downstream-side end of the fuse 52 is greater than or equal to the threshold, the voltage outputted from the resistors R22 and R23 to the base of the semiconductor switch 20 via the resistor R21 has a higher pulse amplitude than the pulse signal P2. Thus when the fuse 52 is not blown, the voltage at the base of the semiconductor switch 20, which takes the potential at the emitter as a reference, is not less than the negative predetermined voltage, and the semiconductor switch 20 is therefore off. Accordingly, if the fuse 52 is not blown, the pulse signal P2 will not pass through the semiconductor switch 20.

If the fuse 52 is blown, i.e. if the voltage at the downstream-side end of the fuse 52 is less than the threshold, when the pulse of the pulse signal P2 is inputted to the emitter of the semiconductor switch 20, the voltage at the base of the semiconductor switch 20, which takes the potential at the emitter as a reference, is less than the negative predetermined voltage, and the semiconductor switch 20 is therefore on. Accordingly, if the fuse 52 is blown, the pulse signal P2 will pass through the semiconductor switch 20.

Note that if the fuse 52 is blown, when a part of the pulse signal P2 aside from the pulse is inputted to the emitter of the semiconductor switch 20, the voltage at the base of the semiconductor switch 20, which takes the potential at the emitter as a reference, is substantially zero V. That is, the voltage at the base of the semiconductor switch 20, which takes the potential at the emitter as a reference, is greater than or equal to the predetermined voltage. The semiconductor switch 20 is off at this time.

The semiconductor switch 30 and the resistors R30, R31, R32, and R33 function the same way as the semiconductor switch 20 and the resistors R20, R21, R22, and R23. Thus if the fuse 53 is not blown, the pulse signal P3 will not pass through the semiconductor switch 30, but if the fuse 53 is blown, the pulse signal P3 will pass through the semiconductor switch 30.

The semiconductor switch 40 and the resistors R40, R41, R42, and R43 function the same way as the semiconductor switch 20 and the resistors R20, R21, R22, and R23. Thus if the fuse 54 is not blown, the pulse signal P4 will not pass through the semiconductor switch 40, but if the fuse 54 is blown, the pulse signal P4 will pass through the semiconductor switch 40.

As described above, the semiconductor switches 20, 30, and 40 correspond to the fuses 52, 53, and 54, respectively. The synthesis circuit 50 can be configured simply, by using the three semiconductor switches 20, 30, and 40.

In the synthesis circuit 50, the synthesized signal Pt of the one or more pulse signals corresponding to a fuse, among the three fuses 52, 53, and 54, having a downstream-side end voltage that is less than the threshold, is outputted from the output terminal Bt to the microcomputer 51.

As one example, if none of the fuses 52, 53, and 54 are blown, the pulse signals P2, P3, and P4 do not pass through the semiconductor switches 20, 30, and 40, respectively. Thus if none of the fuses 52, 53, and 54 are blown, the voltage of the synthesized signal Pt, which takes the ground potential as a reference, remains at substantially zero V, as illustrated in FIG. 4.

As another example, if only the fuse 53 is blown, the pulse signals P2 and P4 will not pass through the semiconductor switches 20 and 40, but the pulse signal P3 will pass through the semiconductor switch 30. Thus if only the fuse 53 is blown, the pulse signal P3, i.e. a pulse in a position corresponding to the fuse 53, is present in the synthesized signal Pt, as illustrated in FIG. 4.

In the synthesized signal Pt, pulses are present in positions corresponding to the fuses, among the fuses 52, 53, and 54, that are blown. Thus if all of the fuses 52, 53, and 54 are blown, pulses are present, in the synthesized signal Pt, in the positions corresponding to the pulse signals P2, P3, and P4.

As described above, the microcomputer 51 outputs the pulse signals P2, P3, and P4 to the input terminals A2, A3, and A4 of the synthesis circuit 50, and identifies a blown fuse, among the three fuses 52, 53, and 54, on the basis of the synthesized signal Pt outputted from the output terminal Bt of the synthesis circuit 50.

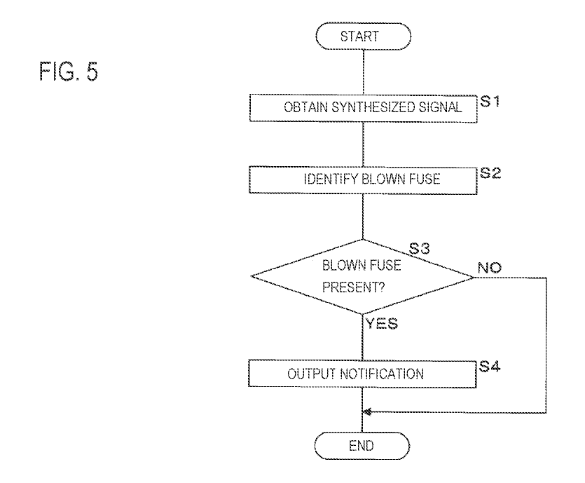

FIG. 5 is a flowchart illustrating a sequence of operations executed by the microcomputer 51. First, the microcomputer 51 obtains the synthesized signal Pt outputted from the output terminal Bt of the synthesis circuit 50 by outputting the pulse signals P2, P3, and P4 to the input terminals A2, A3, and A4, respectively, of the synthesis circuit 50 (step S1).

Next, the microcomputer 51 identifies one or more blown fuses, among the three fuses 52, 53, and 54, on the basis of the positions of the pulses in the synthesized signal Pt obtained in step S1 (step S2). If in step S2 there are no pulses in the synthesized signal Pt, the microcomputer 51 determines that there are no blown fuses. The microcomputer 51 also functions as an identifying unit.

Next, the microcomputer 51 determines whether or not there is a blown fuse on the basis of the result of the identification carried out in step S2 (step S3). If the microcomputer 51 determines that there is a blown fuse (S3: YES), the microcomputer 51 outputs the notification signal indicating the one or more fuses identified in step S2 to the notifying unit 7 (step S4). Accordingly, the notifying unit 7 makes a notification about the one or more fuses indicated by the notification signal, as described above.

The operations end upon the microcomputer 51 determining that there are no blown fuses (S3: NO) or upon step S4 being executed. The microcomputer 51 repeatedly executes the above-described operations periodically.

According to the protective device 5 configured as described above, the microcomputer 51 can identify a blown fuse among the three fuses 52, 53, and 54 with a high level of accuracy on the basis of the voltages at the downstream-side ends.

Additionally, the notifying unit 7 makes a notification about the blown fuses among the fuses 52, 53, and 54, and thus it is not necessary to confirm, e.g. visually, whether or not each of the fuses 52, 53, and 54 is blown. The fuses 52, 53, and 54 can therefore be installed in places with poor visibility. This increases the freedom with which the fuses 52, 53, and 54 can be installed, and makes it possible to reduce the amount of wiring in the power source system 1. Furthermore, because it is not necessary to visually identify the blown fuse, the amount of time required to repair a blown fuse among the fuses 52, 53, and 54 can be shortened as well.

Note that the semiconductor switches 20, 30, and 40 are not limited to PNP bipolar transistors, and may instead be P-channel FETs (Field Effect Transistors), for example. In this case, the emitters, collectors, and bases correspond to sources, drains, and gates, respectively.

### Second Embodiment

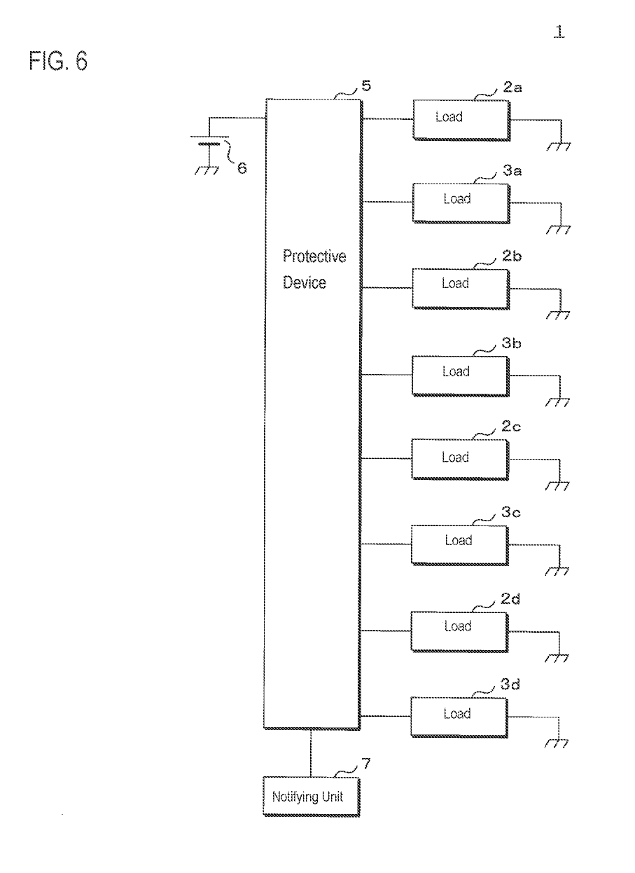

FIG. 6 is a block diagram illustrating the primary configuration of the power source system 1 according to a second embodiment.

Hereinafter, points of the second embodiment that are different from the first embodiment will be described. Configurations aside from those described hereinafter are the same as in the first embodiment. As such, constituent elements that are the same as in the first embodiment will be given the same reference signs as in the first embodiment, and descriptions thereof will be omitted.

The power source system 1 according to the second embodiment can also be favorably installed in a vehicle, and as in the first embodiment, includes the protective device 5, the battery 6, and the notifying unit 7. These are connected in the same manner as in the first embodiment. The power source system 1 according to the second embodiment further includes eight loads 2a, 3a, 2b, 3b, 2c, 3c, 2d, and 3d. One end of each of the loads 2a, 3a, 2b, 3b, 2c, 3c, 2d, and 3d is connected to the protective device 5. The negative terminal of the battery 6 and the other end of each of the loads 2a, 3a, 2b, 3b, 2c, 3c, 2d, and 3d are grounded.

The battery 6 supplies power to the eight loads 2a, 3a, 2b, 3b, 2c, 3c, 2d, and 3d via the protective device 5. The loads 2a, 3a, 2b, 3b, 2c, 3c, 2d, and 3d operate using the power supplied from the battery 6.

The protective device 5 protects the loads 2a, 3a, 2b, 3b, 2c, 3c, 2d, and 3d from overcurrent. When current greater than or equal to a predetermined current flows from the battery 6 to at least one of the loads 2a, 3a, 2b, 3b, 2c, 3c, 2d, and 3d, the connection between the battery 6 and the load, among the loads 2a, 3a, 2b, 3b, 2c, 3c, 2d, and 3d, in which the current greater than or equal to the predetermined current is flowing, is cut off, and a notification signal is outputted to the notifying unit 7.

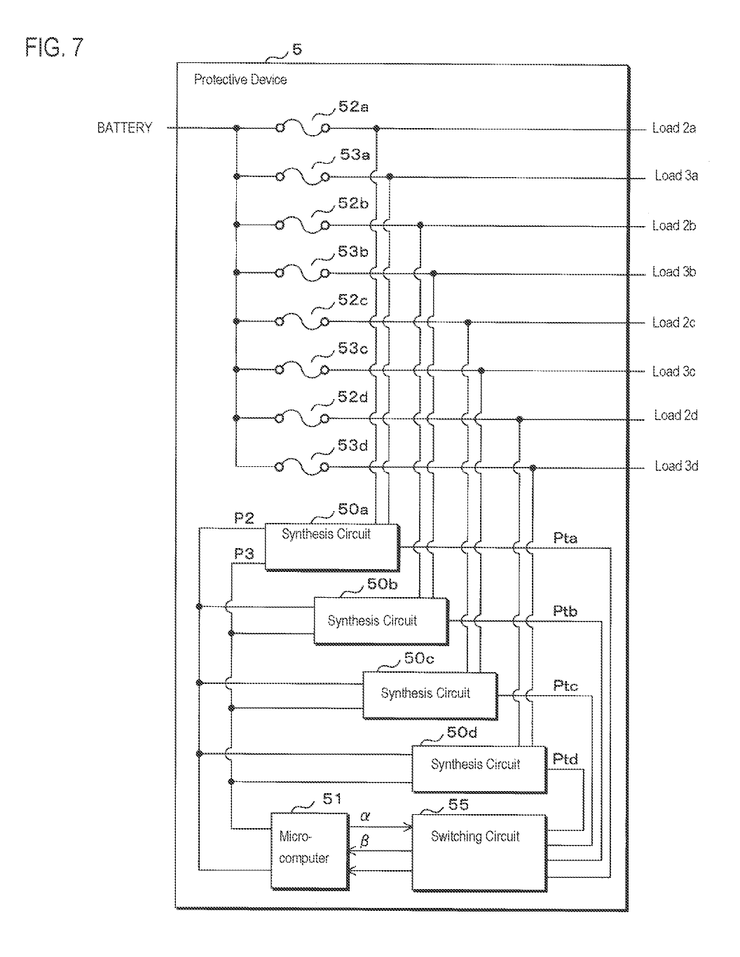

FIG. 7 is a block diagram illustrating the primary configuration of the protective device 5 according to the second embodiment. The protective device 5 according to the second embodiment includes K (=4) synthesis circuits 50a, 50b, 50c, and 50d; the microcomputer 51; eight fuses 52a, 53a, 52b, 53b, 52c, 53c, 52d, and 53d; and a switching circuit 55.

The loads 2a and 3a, the battery 6, the synthesis circuit 50a, and the fuses 52a and 53a in the second embodiment are connected in the same manner as the loads 2 and 3, the battery 6, the synthesis circuit 50, and the fuses 52 and 53 in the first embodiment.

The loads 2b and 3b, the battery 6, the synthesis circuit 50b, and the fuses 52b and 53b are also connected in the same manner as the loads 2 and 3, the battery 6, the synthesis circuit 50, and the fuses 52 and 53 in the first embodiment. The loads 2c and 3c, the battery 6, the synthesis circuit 50c, and the fuses 52c and 53c are also connected in the same manner as the loads 2 and 3, the battery 6, the synthesis circuit 50, and the fuses 52 and 53 in the first embodiment. The loads 2d and 3d, the battery 6, the synthesis circuit 50d, and the fuses 52d and 53d are also connected in the same manner as the loads 2 and 3, the battery 6, the synthesis circuit 50, and the fuses 52 and 53 in the first embodiment.

The eight fuses 52a, 53a, 52b, 53b, 52c, 53c, 52d, and 53d are divided into K (=4) fuse groups. The two fuses 52a and 53a form a single fuse group, and the synthesis circuit 50a corresponds to that fuse group. The two fuses 52b and 53b form a single fuse group, and the synthesis circuit 50b corresponds to that fuse group. The two fuses 52c and 53c form a single fuse group, and the synthesis circuit 50c corresponds to that fuse group. The two fuses 52d and 53d form a single fuse group, and the synthesis circuit 50d corresponds to that fuse group. In the second embodiment, the power source system 1 includes K (=4) fuse groups. M (=2) fuses belong to each fuse group.

In the protective device 5 according to the second embodiment, current flows from the positive terminal of the battery 6 to the loads 2a, 3a, 2b, 3b, 2c, 3c, 2d, and 3d via the fuses 52a, 53a, 52b, 53b, 52c, 53c, 52d, and 53d, respectively. In the protective device 5 according to the second embodiment, eight current paths are provided from the battery 6 to the loads 2a, 3a, 2b, 3b, 2c, 3c, 2d, and 3d, respectively, and the eight fuses 52a, 53a, 52b, 53b, 52c, 53c, 52d, and 53d are provided in the eight current paths, respectively.

Each of the synthesis circuits 50a, 50b, 50c, and 50d is connected to the microcomputer 51 and the switching circuit 55. The switching circuit 55 is further connected to the microcomputer 51.

The microcomputer 51 outputs pulse signals P2 and P3 to each of the K (=4) synthesis circuits 50a, 50b, 50c, and 50d, in the same manner as in the first embodiment. The pulse signal P2 corresponds to the fuses 52a, 52b, 52c, and 52d. The pulse signal P3 corresponds to the fuses 53a, 53b, 53c, and 53d.

The synthesis circuit 50a has a configuration similar to that of the synthesis circuit 50 according to the first embodiment. The synthesis circuit 50a includes the constituent elements of the synthesis circuit 50 according to the first embodiment aside from the semiconductor switch 40, the resistors R40, R41, R42, and R43, and the input terminals A4 and T4. Accordingly, the synthesis circuit 50a includes M (=2) semiconductor switches 20 and 30, M (=2) input terminals A2 and A3, and the output terminal Bt.

M (=2) pulse signals P2 and P3 respectively corresponding to the M (=2) fuses 52a and 53a belonging to the fuse group corresponding to the synthesis circuit 50a are inputted into the input terminals A2 and A3, respectively, of the synthesis circuit 50a. The M (=2) semiconductor switches 20 and 30 of the synthesis circuit 50a correspond to the M (=2) fuses 52a and 53a, respectively. The emitters of the M (=2) semiconductor switches 20 and 30 are connected to the M (=2) input terminals A2 and A3, respectively, of the synthesis circuit 50a. The collectors of the M (=2) semiconductor switches 20 and 30 of the synthesis circuit 50a are connected to the output terminal Bt.

The synthesis circuit 50a also functions in a manner similar to the synthesis circuit 50 according to the first embodiment. That is, of the M (=2) pulse signals P2 and P3 outputted by the microcomputer 51 and corresponding to the M (=2) fuses 52a and 53a belonging to the fuse group corresponding to the synthesis circuit 50a, the synthesis circuit 50a synthesizes the pulse signal corresponding to a fuse having a downstream-side end voltage that is less than a threshold. The synthesis circuit 50a outputs a synthesized signal Pta obtained from the synthesis to the switching circuit 55.

Specifically, the semiconductor switch 20 of the synthesis circuit 50a allows the pulse signal P2 to pass when the downstream-side end voltage of the fuse 52a corresponding to the semiconductor switch 20 is less than a threshold. The semiconductor switch 30 of the synthesis circuit 50a allows the pulse signal P3 to pass when the downstream-side end voltage of the fuse 53a corresponding to the semiconductor switch 30 is less than a threshold.

The configurations and functions of the synthesis circuits 50b, 50c, and 50d are the same as the configuration and functions of the synthesis circuit 50a. The configuration and functions of the synthesis circuit 50b can be described by replacing the synthesis circuit 50a, the fuses 52a and 53a, and the synthesized signal Pta in the descriptions of the configuration and functions of the synthesis circuit 50a with the synthesis circuit 50b, the fuses 52b and 53b, and a synthesized signal Ptb. The configuration and functions of the synthesis circuit 50c can be described by replacing the synthesis circuit 50a, the fuses 52a and 53a, and the synthesized signal Pta in the descriptions of the configuration and functions of the synthesis circuit 50a with the synthesis circuit 50c, the fuses 52c and 53c, and a synthesized signal Ptc. The configuration and functions of the synthesis circuit 50d can be described by replacing the synthesis circuit 50a, the fuses 52a and 53a, and the synthesized signal Pta in the descriptions of the configuration and functions of the synthesis circuit 50a with the synthesis circuit 50d, the fuses 52d and 53d, and a synthesized signal Ptd. Thus like the first embodiment, the synthesis circuits 50a, 50b, 50c, and 50d can be configured simply, by using the two semiconductor switches 20 and 30.

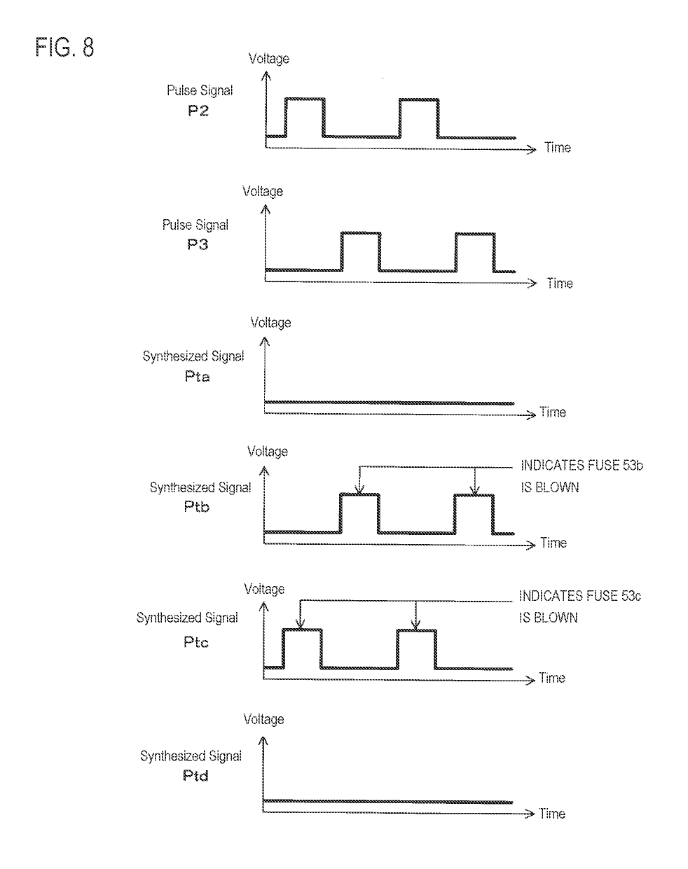

FIG. 8 is a waveform diagram illustrating the pulse signals P2 and P3 and the synthesized signals Pta, Ptb, Ptc, and Ptd. The periods of the pulse signals P2 and P3 in the second embodiment are shorter than the periods of the pulse signals P2 and P3, respectively, in the first embodiment. Examples of the synthesized signals Pta, Ptb, Ptc, and Ptd are illustrated in FIG. 8.

If pulses are present in the synthesized signal Pta in positions corresponding to the pulse signal P2, the synthesized signal Pta indicates that the fuse 52a has blown. If pulses are not present in the synthesized signal Pta in positions corresponding to the pulse signal P2, the synthesized signal Pta indicates that the fuse 52a has not blown. Likewise, if pulses are present in the synthesized signal Pta in positions corresponding to the pulse signal P3, the synthesized signal Pta indicates that the fuse 53a has blown. If pulses are present in the synthesized signal Pta in positions corresponding to the pulse signal P3, the synthesized signal Pta indicates that the fuse 53a has blown.

Like the synthesized signal Pta, the synthesized signal Ptb indicates whether or not the fuses 52b and 53b have blown. Like the synthesized signal Pta, the synthesized signal Ptc indicates whether or not the fuses 52c and 53c have blown. Like the synthesized signal Pta, the synthesized signal Ptd indicates whether or not the fuses 52d and 53d have blown.

In the example illustrated in FIG. 8, the voltage of the synthesized signal Pta stays at substantially zero V, and thus there are no pulses in positions corresponding to the pulse signals P2 and P3. As such, neither of the fuses 52a and 53a have blown. In the synthesized signal Ptb, there is no pulse in the position corresponding to the pulse signal P2, but there is a pulse in the position corresponding to the pulse signal P3. As such, the fuse 52b has not blown, but the fuse 53b has blown. In the synthesized signal Ptc, there is a pulse in the position corresponding to the pulse signal P2, but no pulse in the position corresponding to the pulse signal P3. As such, the fuse 52c has blown, but the fuse 53c has not blown. The voltage of the synthesized signal Ptd stays at substantially zero V, and thus there are no pulses in positions corresponding to the pulse signals P2 and P3. As such, neither of the fuses 52d and 53d have blown.

The microcomputer 51 outputs two selection signals α and β to the switching circuit 55. Each of the selection signals α and β is a binary signal having a high-level voltage and a low-level voltage. The switching circuit 55 outputs one of the synthesized signals Pta, Ptb, Ptc, and Ptd to the microcomputer 51 on the basis of the details of the two selection signals α and β. The microcomputer 51 selects one of the K (=4) synthesized signals Pta, Ptb, Ptc, and Ptd and sets the voltages of the selection signals α and β in accordance with the result of the selection. As a result, the switching circuit 55 outputs the synthesized signal, among the K (=4) synthesized signals Pta, Ptb, Ptc, and Ptd, that has been selected by the microcomputer 51 to the microcomputer 51. The microcomputer 51 functions not only as an output unit and a identifying unit, but also as a selecting unit, and the switching circuit 55 functions as a second output unit.

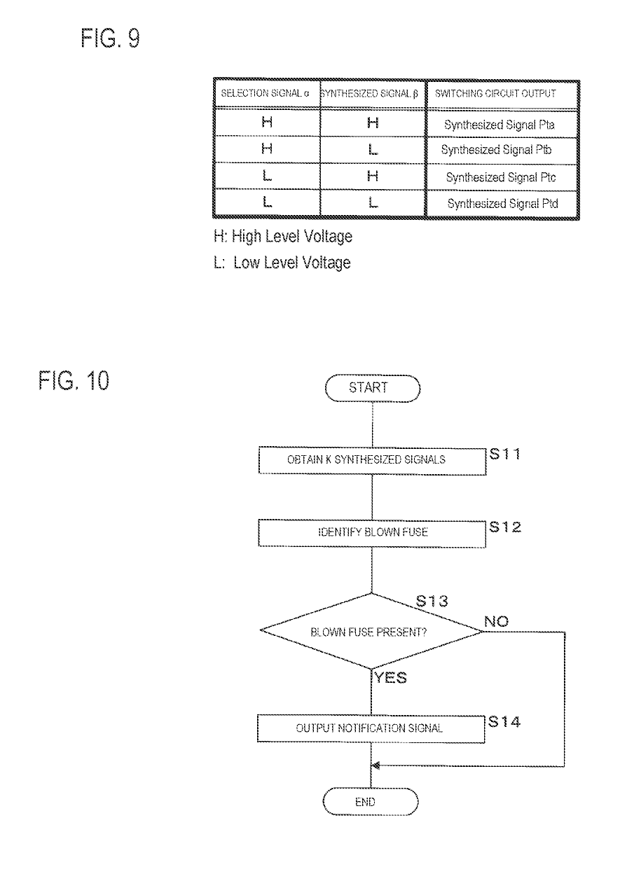

FIG. 9 is a table for describing operations of the switching circuit 55. In FIG. 9, the high-level voltage is indicated by “H” and the low-level voltage is indicated by “L”. When the microcomputer 51 has set the voltages of both the selection signals α and β to the high-level voltage, the switching circuit 55 outputs the synthesized signal Pta to the microcomputer 51. When the microcomputer 51 has set the voltage of the selection signal α to the high-level voltage and the voltage of the selection signal β to the low-level voltage, the switching circuit 55 outputs the synthesized signal Ptb to the microcomputer 51. When the microcomputer 51 has set the voltage of the selection signal α to the low-level voltage and the voltage of the selection signal β to the high-level voltage, the switching circuit 55 outputs the synthesized signal Ptc to the microcomputer 51. When the microcomputer 51 has set the voltages of both the selection signals α and β to the low-level voltage, the switching circuit 55 outputs the synthesized signal Ptd to the microcomputer 51.

FIG. 10 is a flowchart illustrating a sequence of operations executed by the microcomputer 51. First, the microcomputer 51 obtains the K (=4) synthesized signals Pta, Ptb, Ptc, and Ptd outputted by the switching circuit 55 by changing the voltages of the selection signals α and β in order from (H,H), to (H,L), to (L,H), and to (L,L) while outputting the pulse signals P2 and P3 to the synthesis circuits 50a, 50b, and 50c (step S11). Here, “H” indicates the high-level voltage and “L” indicates the low-level voltage.

Next, the microcomputer 51 identifies one or more fuses, among the eight fuses 52a, 53a, 52b, 53b, 52c, 53c, 52d, and 53d, that have blown on the basis of the positions of pulses in the K (=4) synthesized signals Pta, Ptb, Ptc, and Ptd obtained in step S11 (step S12). If in step S12 there are no pulses in any of the K (=4) synthesized signals Pta, Ptb, Ptc, and Ptd, the microcomputer 51 determines that there are no blown fuses.

Next, the microcomputer 51 determines whether or not there is a blown fuse on the basis of the result of the identification carried out in step S12 (step S13). If the microcomputer 51 determines that there is a blown fuse (S13: YES), the microcomputer 51 outputs the notification signal indicating the one or more fuses identified in step S12 to the notifying unit 7 (step S14). Accordingly, the notifying unit 7 makes a notification about the one or more fuses indicated by the notification signal, as described above.

The operations end upon the microcomputer 51 determining that there are no blown fuses (S13: NO) or upon step S14 being executed. The microcomputer 51 repeatedly executes the above-described operations periodically.

In the protective device 5 according to the second embodiment, the microcomputer 51 can identify a blown fuse among the eight fuses 52a, 53a, 52b, 53b, 52c, 53c, 52d, and 53d with a high level of accuracy on the basis of the voltages at the downstream-side ends, in the same manner as in the first embodiment. Furthermore, because the switching circuit 55 is provided, the pulse signal P2 can be associated with the four fuses 52a, 52b, 52c, and 52d, and the pulse signal P3 can be associated with the four fuses 53a, 53b, 53c, and 53d. Thus the microcomputer 51 outputs a lower number of pulse signals.

Note that in the second embodiment, the number of fuses included in the power source system 1 is not limited to eight, and may be four, five, six, or seven, or nine or more. Furthermore, the number of fuse groups K is not limited to four, and may be any number greater than or equal to two. As described above, the number of fuse groups K is the same as the number of synthesis circuits. A number of selection signals U satisfies 2u−1<K≤2u. For example, if the number of fuse groups K is five to eight, the number of selection signals U is three.

Additionally, the number of fuses M belonging to each of the K fuse groups need not be the same. For example, the number of fuses M belonging to one fuse group may be two, and the number of fuses M belonging to another fuse group may be three. In this case, a synthesis circuit including three input terminals and three semiconductor switches, e.g. the synthesis circuit 50 according to the first embodiment, can be used as one of the synthesis circuits in the protective device 5. Synthesis circuits in which the number of input terminals and semiconductor switches is the same as the number of fuses M are used in the protective device 5.

Two or more fuses belong to each fuse group. The number of pulse signals outputted by the microcomputer 51 is the same as the highest number of fuses belonging to the respective K fuse groups. For example, if the numbers of fuses belonging to a first fuse group, a second fuse group, and a third fuse group are three, four, and three, respectively, the number of pulse signals is four. The accuracy of identifying blown fuses is not affected by the number of fuses in the power source system 1.

### Third Embodiment

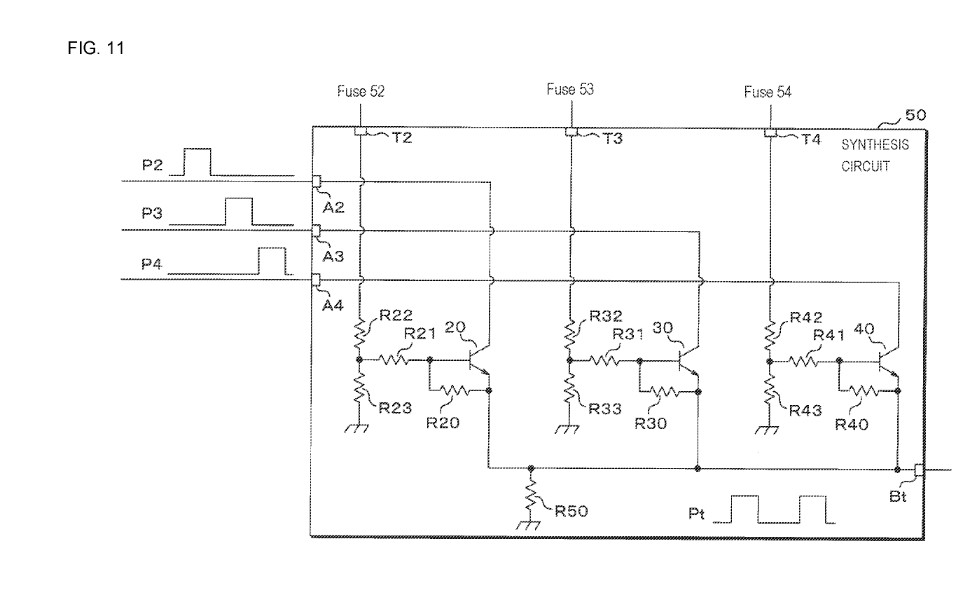

FIG. 11 is a circuit diagram illustrating the synthesis circuit 50 according to a third embodiment.

Hereinafter, points of the third embodiment that are different from the first embodiment will be described. Configurations aside from those described hereinafter are the same as in the first embodiment. As such, constituent elements that are the same as in the first embodiment will be given the same reference signs as in the first embodiment, and descriptions thereof will be omitted.

In the synthesis circuit 50 according to the third embodiment, the semiconductor switches 20, 30, and 40 are NPN bipolar transistors. The collectors of the semiconductor switches 20, 30, and 40 are connected to the input terminals A2, A3, and A4, respectively. The emitters of the semiconductor switches 20, 30, and 40 are connected to one end of the resistor R50 and to the output terminal Bt. The other end of the resistor R50 is grounded. The resistors R20, R30, and R40 are connected between the emitter and the base of the semiconductor switches 20, 30, and 40, respectively.

In each of the semiconductor switches 20, 30, and 40, current can flow between the emitter and the collector when a voltage at the base, which takes a potential at the emitter as a reference, is greater than or equal to a positive second predetermined voltage. The semiconductor switches 20, 30, and 40 are on at this time. In each of the semiconductor switches 20, 30, and 40, current does not flow between the emitter and the collector when the voltage at the base, which takes the emitter as a reference, is less than the second predetermined voltage. The semiconductor switches 20, 30, and 40 are off at this time.

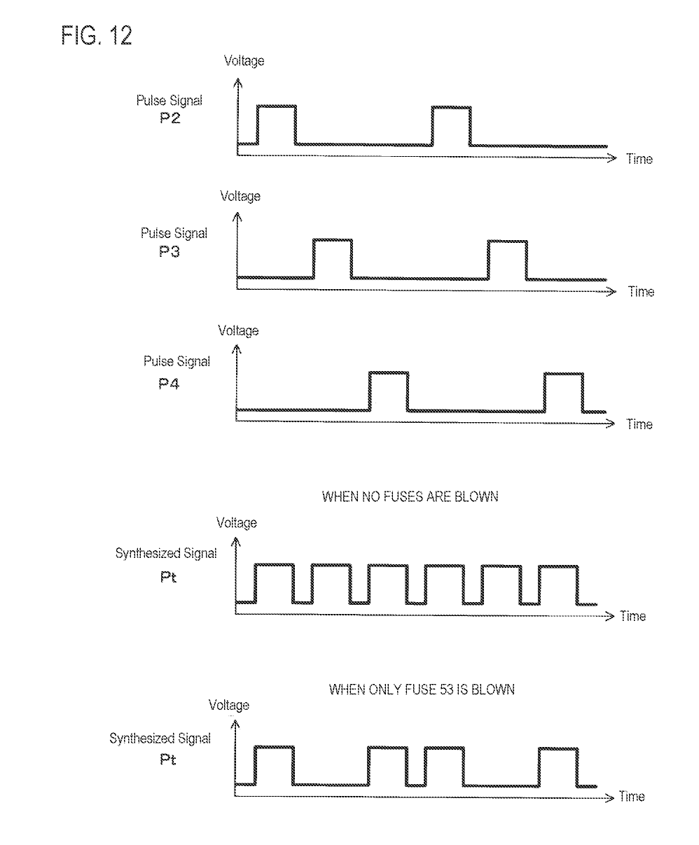

FIG. 12 is a waveform diagram illustrating the pulse signals P2, P3, and P4 and the synthesized signal Pt. FIG. 12 illustrates the waveform of the synthesized signal Pt when none of the fuses 52, 53, and 54 are blown, and the waveform of the synthesized signal Pt when the fuse 53 is blown.

If the fuse 52 is not blown, i.e. if the voltage at the downstream-side end of the fuse 52 is greater than or equal to a threshold, the voltage outputted from the resistors R22 and R23 to the base of the semiconductor switch 20 via the resistor R21 is high. Accordingly, in the semiconductor switch 20, the voltage at the base, which takes the potential at the emitter as a reference, is greater than or equal to the positive second predetermined voltage, and thus the semiconductor switch 20 is on. Accordingly, if the fuse 52 is not blown, the pulse signal P2 will pass through the semiconductor switch 20.

If the fuse 52 is blown, i.e. if the voltage at the downstream-side end of the fuse 52 is less than the threshold, the voltage outputted from the resistors R22 and R23 to the base of the semiconductor switch 20 via the resistor R21 is low. Accordingly, in the semiconductor switch 20, the voltage at the base, which takes the potential at the emitter as a reference, is less than the positive second predetermined voltage, and thus the semiconductor switch 20 is off. Accordingly, if the fuse 52 is blown, the pulse signal P2 will not pass through the semiconductor switch 20.

The semiconductor switch 30 and the resistors R30, R31, R32, and R33 function the same way as the semiconductor switch 20 and the resistors R20, R21, R22, and R23. Thus if the fuse 53 is not blown, the pulse signal P3 will pass through the semiconductor switch 30, but if the fuse 53 is blown, the pulse signal P3 will not pass through the semiconductor switch 30.

The semiconductor switch 40 and the resistors R40, R41, R42, and R43 function the same way as the semiconductor switch 20 and the resistors R20, R21, R22, and R23. Thus if the fuse 54 is not blown, the pulse signal P4 will pass through the semiconductor switch 40, but if the fuse 54 is blown, the pulse signal P4 will not pass through the semiconductor switch 40.

The synthesis circuit 50 according to the third embodiment configured as described above synthesizes one or more of the pulse signals, among the three pulse signals P2, P3, and P4 outputted by the microcomputer 51, that correspond to a fuse having a downstream-side end voltage that is greater than or equal to the threshold. The synthesis circuit 50 outputs the synthesized signal Pt obtained by synthesizing the one or more pulse signals to the microcomputer 51.

According to the third embodiment as well, the semiconductor switches 20, 30, and 40 correspond to the fuses 52, 53, and 54, respectively, and the synthesis circuit 50 can be configured simply, by using the three semiconductor switches 20, 30, and 40.

As one example, if none of the fuses 52, 53, and 54 are blown, the pulse signals P2, P3, and P4 pass through the semiconductor switches 20, 30, and 40, respectively. Thus if none of the fuses 52, 53, and 54 are blown, pulses corresponding to each of the pulse signals P2, P3, and P4 are present in the synthesized signal Pt, as illustrated in FIG. 12.

As another example, if only the fuse 53 is blown, the pulse signals P2 and P4 will pass through the semiconductor switches 20 and 40, but the pulse signal P3 will not pass through the semiconductor switch 30. Thus if only the fuse 53 is blown, the pulse signal P3, i.e. a pulse in the position corresponding to the fuse 53, is not present in the synthesized signal Pt, as illustrated in FIG. 12.

In the synthesized signal Pt, no pulses are present in positions corresponding to the fuses, among the fuses 52, 53, and 54, that are blown. Thus if all of the fuses 52, 53, and 54 are blown, the voltage of the synthesized signal Pt, which takes the ground potential as a reference, remains at substantially zero V.

The microcomputer 51 according to the third embodiment functions in the same manner as the microcomputer 51 according to the first embodiment. However, in the third embodiment, if in step S2 there are pulses corresponding to all of the pulse signals P2, P3, and P4 in the synthesized signal Pt, the microcomputer 51 determines that there are no blown fuses.

In the third embodiment, in step S2, the microcomputer 51 identifies one or more blown fuses from the positions of pulses that are absent from the synthesized signal Pt.

The protective device 5 according to the third embodiment configured as described thus far achieves the same effects as the protective device 5 according to the first embodiment.

Note that in the third embodiment, the semiconductor switches 20, 30, and 40 are not limited to NPN bipolar transistors, and may be N-channel FETs, for example. In this case, the collectors, emitters, and bases correspond to drains, sources, and gates, respectively.

Furthermore, in the first and third embodiments, the number of loads is not limited to three, and may be two, or four or more. The number of loads, the number of fuses, and the number of semiconductor switches in the synthesis circuit 50 are the same. The accuracy of identifying blown fuses is not affected by the number of fuses. A synthesis circuit 50 in which the number of input terminals and semiconductor switches is the same as the number of fuses is used in the protective device 5 according to the first and third embodiments.

### Fourth Embodiment

Each of the K synthesis circuits in the second embodiment may have configurations similar to that of the synthesis circuit 50 according to the third embodiment.

In this case, each of the K synthesis circuits synthesizes the pulse signals, among the M pulse signals outputted by the microcomputer 51 and that correspond to the M fuses belonging to the fuse group corresponding to that synthesis circuit, that correspond to fuses having a downstream-side end voltage that is greater than or equal to a threshold. Each of the K synthesis circuits outputs a synthesized signal obtained from the synthesis to the switching circuit 55. In each synthesis circuit, each of the M semiconductor switches allows the pulse signal to pass when the downstream-side end voltage of the fuse to which that semiconductor switch corresponds is greater than or equal to the threshold.

Other configurations aside from those described above in the fourth embodiment are the same as in the second embodiment, and thus detailed descriptions thereof will be omitted. The protective device 5 according to the fourth embodiment configured as described thus far achieves the same effects as the protective device 5 according to the second embodiment.

The first to fourth embodiments disclosed here are intended to be in all ways exemplary and in no ways limiting. The scope of the present invention is defined not by the foregoing descriptions but by the scope of the claims, and is intended to include all changes equivalent in meaning and scope of the claims.

### REFERENCE SIGNS LIST

1 power source system

2, 3, 4, 2a, 3a, 2b, 3b, 2c, 3c load

20, 30, 40 semiconductor switch

5 protective device

50, 50a, 50b, 50c synthesis circuit

51 microcomputer (output unit, selecting unit, identifying unit)

52, 53, 54, 52a, 53a, 52b, 53b, 54a, 54b fuse

55 switching circuit (second output unit)

6 battery

A2, A3, A4 input terminal

Bt output terminal

P2, P3, P4 pulse signal

Pt, Pta, Ptb, Ptc synthesized signal

1. A protective device including a plurality of fuses respectively provided in a plurality of current paths from a battery to a corresponding plurality of loads, the device comprising:
an output unit that outputs a plurality of pulse signals, each of the pulse signals corresponding to one of the plurality of fuses, and the pulse signals having pulses in mutually-different positions;
a synthesis circuit that synthesizes a pulse signal, among the plurality of pulse signals outputted by the output unit, corresponding to a fuse that has a voltage on a downstream-side end less than a threshold or greater than or equal to a threshold; and
an identifying unit that identifies a blown fuse on the basis of the synthesized signal synthesized by the synthesis circuit.

2. The protective device according to claim 1,
wherein the synthesis circuit includes:
a plurality of input terminals into which the plurality of pulse signals are respectively inputted;
a plurality of switches, each of the switches corresponding to one of the plurality of fuses, and one end of each of the switches being connected to a corresponding one of the plurality of input terminals; and
an output terminal connected to another end of each of the plurality of switches, and
wherein each of the plurality of switches is configured to allow a corresponding one of the pulse signals to pass in the case where the voltage on the downstream-side end of the fuse corresponding to that switch is less than the threshold or greater than or equal to the threshold.

3. A protective device including a plurality of fuses respectively provided in a plurality of current paths from a battery to a corresponding plurality of loads,
the plurality of fuses being divided into K (≥2) fuse groups, and
the device comprising:
an output unit that outputs a plurality of pulse signals, each of the pulse signals corresponding to one fuse belonging to each of one or more fuse groups among the K fuse groups, and the pulse signals having pulses in mutually-different positions;
K synthesis circuits, each corresponding to one of the K fuse groups, that each synthesizes a pulse signal, among M (≥2) pulse signals outputted by the output unit and corresponding to M fuses belonging to the fuse group to which that synthesis circuit corresponds, corresponding to a fuse that has a voltage on a downstream-side end less than a threshold or greater than or equal to a threshold;
a selecting unit that selects one of the K synthesized signals synthesized by the K synthesis circuits;
a second output unit that outputs the synthesized signal selected by the selecting unit; and
an identifying unit that identifies a blown fuse on the basis of the synthesized signal outputted by the second output unit.

4. The protective device according to claim 3,
wherein each of the K synthesis circuits includes:
M input terminals into which the respective M pulse signals corresponding to the M fuses belonging to the fuse group to which the synthesis circuit corresponds are inputted;
M switches, each of the switches corresponding to one of the M fuses, and one end of each of the switches being connected to a corresponding one of the M input terminals; and
an output terminal connected to another end of each of the M switches, and
wherein each of the M switches is configured to allow a corresponding one of the pulse signals to pass in the case where the voltage on the downstream-side end of the fuse corresponding to that switch is less than the threshold or greater than or equal to the threshold.

5. A power source system comprising:
the protective device according to claim 1;
the battery; and
the plurality of loads, the loads being supplied with power from the battery via the protective device.
